(19) United States
(12) Patent Application Publication
(10) Pub. No.: US 2022/0132795 A1
(43) Pub. Date: May 5, 2022

(54) Mobile Enclosure

(71) Applicant: Rolling Rodents, LLC, Winston-Salem, NC (US)

(72) Inventors: Adam Haber, Roslyn, NJ (US); Ethan Haber, Winston-Salem, NC (US); William Fiebel, Succasunna, NJ (US); Mark Dorsey, Darien, CT (US); Joohwi Rhi, Oradell, NJ (US); Mathieu Zastawny, Jersey City, NJ (US); Maya Kremien, Austin, TX (US)

(73) Assignee: Rolling Rodents, LLC, Winston-Salem, NC (US)

(21) Appl. No.: 17/172,661

(22) Filed: Feb. 10, 2021

Related U.S. Application Data
(60) Provisional application No. 62/972,591, filed on Feb. 10, 2020.

(51) Int. Cl. A01K 1/03; A01K 15/02; A01K 1/00

(52) U.S. Cl. CPC A01K 1/03; A01K 1/0064; A01K 15/027

(57) ABSTRACT

The current disclosure is directed to a mobile environment for the transportation of hamsters, other small rodents, or small animals kept as pets. This mobile environment allows the user to easily carry the pet hamster on the go. This mobile environment is based on the idea of stacking multiple areas for the hamster to interact. The bottom portion serves as the hideout for the hamster, providing shade, a place to tunnel into bedding, and a place to have food that is easily accessible. Above the “hide-away” portion is the exercise wheel. This wheel sits horizontally and spins freely, providing an easily accessible form of exercise for the hamster. Lastly, the funneling form on the top of the mobile environment provides a means to attach a water bottle for hydration on the go.

### CROSS-REFERENCE TO RELATED APPLICATIONS

Provisional application No. 62/972,591, filed on Feb. 10, 2020

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### REFERENCE TO A SEQUENCE LISTING

Not Applicable

### BACKGROUND

The current disclosure is directed to a mobile environment for the transportation of hamsters, other small rodents, or small animals kept as pets. When it comes to cages and transport systems for hamsters and other small rodents, there are several options available that miniaturize the larger home pet environments and are designed to be more manageable on the go. Applicant believes that improvements can be made in terms of at least one of the types of novelty methods produced and the efficiencies gained for a mobile enclosure for hamsters. It is to at least one of these, or additional problems that the current disclosure is directed.

### SUMMARY

By way of summary, the current disclosure is directed to a mobile environment for the transportation of hamsters, other small rodents, or small animals kept as pets. This mobile environment allows the user to easily carry the pet hamster on the go. This mobile environment is based on the idea of stacking multiple areas for the hamster to interact. The bottom portion serves as the hideout for the hamster, providing shade, a place to tunnel into bedding, and a place to have food that is easily accessible. Above the “hide-away” portion is the exercise wheel. This wheel sits horizontally and spins freely, providing an easily accessible form of exercise for the hamster. Lastly, the funneling form on the top of the mobile environment provides a means to attach a water bottle for hydration on the go.

This product is intended to be used as a temporary, mobile enclosure for small pets, extending the opportunities of interaction between pet and owner. The mobile enclosure is made up of several parts, including a water bottle, the body of the enclosure (top and base), an exercise wheel, vertical tube, and hideout insert. The mobile enclosure shape is iconic and unique among hamster products. The way the bottle connects to the enclosure is unique and directly relates to the shape of the body of the enclosure (funneling on top of enclosure allows for unique bottle mounting feature using an O-ring). The vertical nature of the enclosure is unique and iconic among other small pets' products; it relies on building in a usable space stacked vertically to create a more efficient, compact enclosure. The flat wheel design is unique and iconic, allowing for more efficiency in usable space, and the “wheel” is used as both a spinning exercise solution and a platform for the small pets to walk around. The tube connecting the wheel to the body of the enclosure is unique in that it serves as both the method by which the hamster moves from space to space, and the axle on which the wheel spins.

Applicant believes that improvements have been made in terms of at least one of the types of novelty methods produced and the efficiencies gained for the mobile hamster enclosure. It is to at least one of these, or additional problems that the current disclosure is directed.

Other examples will be set forth in more detail in the figures and detailed description below. The current disclosure is also directed to methods of adaptation and use. It will be apparent; however, that the detailed description is not intended to limit the present invention.

### BRIEF DESCRIPTION OF THE SEVERAL VIEWS OF THE DRAWING

The accompanying drawings form part of this specification and the invention will be better understood by a reading of the Detailed Description of the Examples of the Invention along with a review of said drawings wherein:

FIG. 1 illustrates the unique and iconic shape of the mobile enclosure, the modular nature of the enclosure and the way the enclosure comes together to create layers of usable space.

FIG. 2 illustrates the way that the tube acts as the axle on which the flat wheel spins.

FIG. 3 illustrates the side view of the mobile enclosure.

FIG. 4 illustrates the bottle piece, the O-Ring piece, the top piece, the wheel piece, the hideout insert piece, the tube piece, the handle piece, the base piece, and the way that the bottle fits into the enclosure top.

### DETAILED DESCRIPTION OF THE EXAMPLES OF THE INVENTION

FIG. 1 illustrates the Mobile Enclosure 101 designed to provide hamsters a vehicle for safe travel, while providing access to exercise, as well as a sleeping compartment 104. The Enclosure consists of three layers that can be disassembled for cleaning or rodent access. The bottom layer 104 is the sleeping compartment. The middle layer 103 is the exercise compartment, and the top layer 102 is the Enclosure's lid. In one embodiment, the mobile enclosure is 260 millimeter diameter and 225 millimeters in height. The height of the base section is 78 millimeters, the height of the middle section is 97 millimeters, and the height of the top section is 48 millimeters.

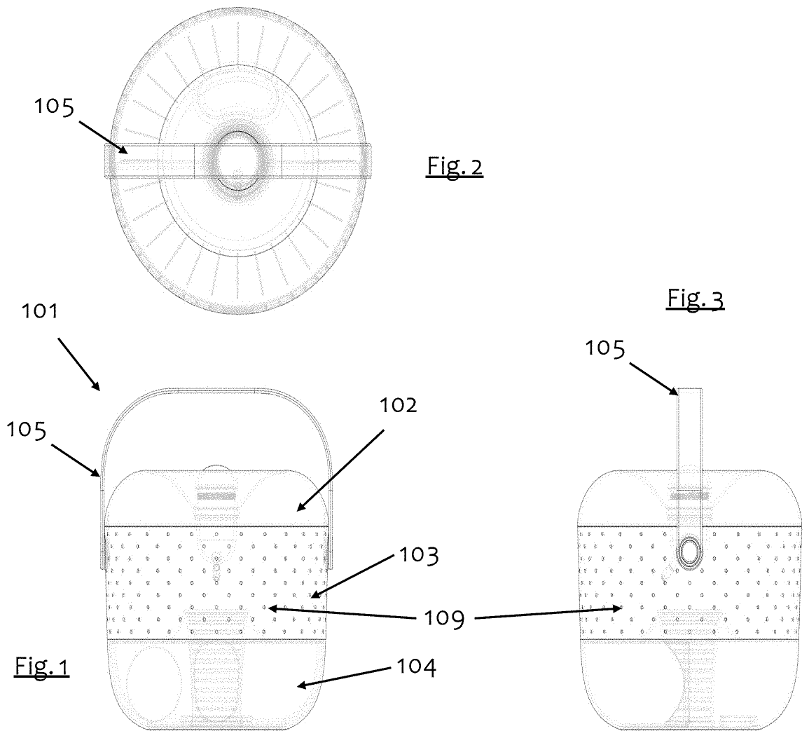

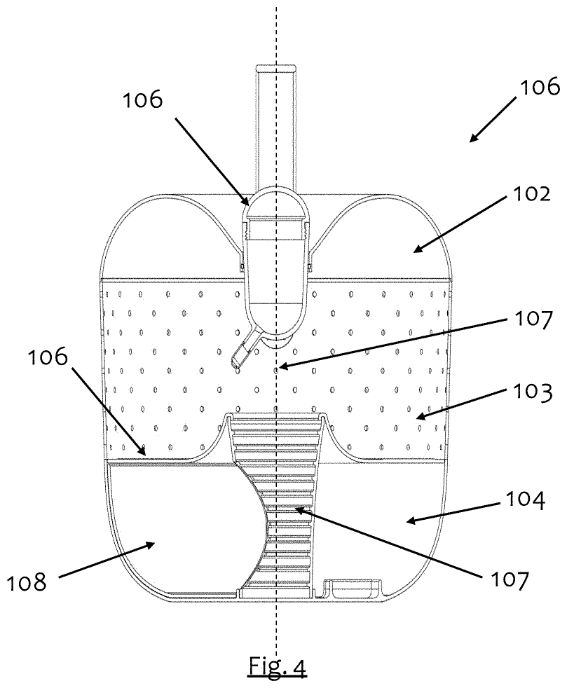

FIG. 2 illustrates the top view of the enclosure. FIG. 3 illustrates the side view of the enclosure depicting the Handle 105 for ease of carrying during transportation. The middle layer also includes a plurality of ventilation apertures 109 that surround the entirety of the layer.

FIG. 4 illustrates the top layer of the enclosure 102 that includes a feature to hold a water bottle 106 which is accessible to drink from the middle layer 103, and removable from the top layer 102. The middle compartment includes an exercise wheel 106 that spins horizontally on a vertical axis 107. The exercise wheel contains a plurality of apertures for the pet to obtain a grip in order to facilitate the spinning of the wheel. The bottom layer 104 includes a stair case 107 that provides rodent access between the middle 103 and bottom layers 104. The bottom layer also includes a rodent enclosure 108 for rodent security.

Insofar as the description above and the accompanying drawings disclose any additional subject matter that is not within the scope of the claims below, the inventions are not dedicated to the public and the right to file one or more applications to claim such additional inventions is reserved.

What is claimed is:

1. A mobile enclosure for pet hamsters and other small rodents that are kept as pets comprising:
a top layer; a middle layer; and a bottom layer;
the mobile enclosure having a diameter of about 208 millimeters to about 312 millimeters,
a height of about 180 to about 270 millimeters,
a base section of about 62.4 millimeters to about 93.6 millimeters in height,
a middle section of about 77.6 millimeters to about 116.4 millimeters in height,
and a top section of about 38.4 millimeters to about 57.6 millimeters in height.

2. The mobile enclosure of claim 1, wherein one of the layers contains a horizontal exercise wheel supported by a tube.

3. The mobile enclosure of claim 2, wherein the bottom layer contains a staircase that provides access to the middle layer.

4. The mobile enclosure of claim 3, wherein the top layer contains a funneling feature for a water bottle mounting using an O-ring that creates a seal.

5. The mobile enclosure of claim 4, wherein a plurality of apertures for ventilation surrounds the middle layer.

6. A mobile enclosure for pet hamsters and other small rodents that are kept as pets comprising: a top layer; a middle layer; and a bottom layer,
the mobile enclosure having a diameter of about 208 millimeters to about 312 millimeters,
a height of about 180 to about 270 millimeters,
a base section of about 62.4 millimeters to about 93.6 millimeters in height,
a middle section of about 77.6 millimeters to about 116.4 millimeters in height,
and a top section of about 38.4 millimeters to about 57.6 millimeters in height,
wherein the one of the layers contains a horizontal exercise wheel supported by a tube,
wherein the bottom layer contains a staircase that provides access to the middle layer,
wherein the top layer contains a funneling feature for a water bottle mounting using an O-ring that provides a seal,
wherein a plurality of apertures for ventilation surrounds the middle layer.
